(19) United States
(12) Patent Application Publication
(10) Pub. No.: US 2012/0050002 A1
(43) Pub. Date: Mar. 1, 2012

(54) APPARATUS HAVING A ROTARY SWITCH

(75) Inventors: Hans Gradl, Teublitz (DE); Stefan Widmann, Freudenberg (DE)

(73) Assignee: SIEMENS AKTIENGESELLSCHAFT, Munich (DE)

(21) Appl. No.: 13/220,976

(22) Filed: Aug. 30, 2011

(30) Foreign Application Priority Data
Aug. 31, 2010 (DE) 10 2010 036 212.3

(51) Int. Cl. G05B 19/02; H01H 3/00

(52) U.S. Cl. 340/4.3; 200/329

(57) ABSTRACT

In an apparatus having a rotary switch which can be moved into a plurality of positions, each of which is assigned a different function of the apparatus, a different input signal is respectively supplied to a microcontroller when each position is assumed. In at least one embodiment, a firmware program accesses a table as external data source, the table directly assigning input signals and output values to one another, that is to say assigning the input signals to a switch position and assigning the switch position to an output value in one go.

### PRIORITY STATEMENTS

The present application hereby claims priority under 35 U.S.C. §119 on German patent application number DE 10 2010 036 212.3 filed Aug. 31, 2010, the entire contents of which are hereby incorporated herein by reference.

### FIELD

At least one embodiment of the invention generally relates to an apparatus and/or to a method for operating such an apparatus.

### BACKGROUND

An apparatus has a rotary switch which can be moved into a plurality of positions. A different function of the apparatus is assigned to each position. The apparatus also has a microcontroller which is coupled to the rotary switch so that a different input signal (which respectively abstractly corresponds to a different input value) is respectively supplied to the microcontroller during operation of the apparatus when each position is assumed. Firmware is run in the microcontroller. For each input signal, the firmware causes the apparatus to operate according to an associated function. In this case, the input signal is assigned an output value which is then used by the microcontroller. Within the scope of such an apparatus, reference is also made to a so-called rotary coding switch because the input signals are understood as having been coded.

In the case of known apparatuses of the generic type mentioned, the output value is assigned to the input signal inside the firmware. This is typically carried out in two stages: the input signal is first of all assigned to a switch position, that is to say the switch position is detected by the firmware on the basis of its associated input signal. The assignment is carried out using a decoding table for the switch position. For the switch position detected, the occupancy is then assigned using a further decoding table. Both decoding tables are generally permanently integrated in the firmware, that is to say cannot be changed without the firmware. The second table which defines the assignment of the occupancy to the switch position is stored outside the firmware; the firmware then accesses this table. The occupancy determines the appearance of the output value. The output value is, for example, a threshold value or a comparison value for a functional unit of the apparatus or relates to a delay time etc.

As a result of the fact that at least that table which assigns the input signal to a switch position is part of the firmware in the prior art, the construction of the apparatus is restricted to a predetermined type of rotary switch by the firmware, that is to say the switches with the same coding (same type of input signals for the same position) must therefore always be used. If this is not wanted, the firmware must be reconfigured, which results in costs for the development of the firmware, for its testing and, in particular, for the so-called type testing (testing for the compliance with standards).

### SUMMARY

In at least one embodiment of the present invention, a greater degree of flexibility is ensured in an apparatus, as far as the use of different rotary switches with different coding is concerned.

At least one embodiment, in one aspect, is directed to an apparatus and, in another aspect, is directed to a method.

The apparatus according to an embodiment of the invention is therefore characterized in that a table which directly assigns the coded input signals (input values) and output values to one another is stored in a memory assigned to the microcontroller as a data source which is external with respect to the firmware program, the firmware program being designed to access the table.

An embodiment of the invention thus dispenses with the two assignment stages, and both stages are simultaneously enabled with the aid of the firmware-external table. As a result of the fact that the table is a data source which is external with respect to the firmware program, the table can be changed without having to change the firmware. This makes it possible to completely change the assignment of input signals to output signals without having to change the firmware. There is thus a greater degree of flexibility since another type of rotary switch can be used by changing the type of coding without having to replace the firmware; rather, it suffices to store another table in the memory.

The same memory as that which stores the firmware program or program code which determines the latter is preferably used as the memory for holding the table. In this case, one memory area is reserved for the program code which is not changed and another memory area is used to hold the table which is defined in a variable manner.

In a manner known per se, the memory may be a read-only memory, preferably an EEPROM, preferably a flash EEPROM (flash memory).

An embodiment of the invention is preferably used when a protective switching device, in particular a circuit breaker (or else a miniature circuit breaker or a residual-current circuit breaker), is provided as the apparatus.

In the method according to an embodiment of the invention for operating an apparatus having a rotary switch on the basis of a position of the latter, an embodiment of the invention provides for a firmware program running in a microcontroller to directly assign an input signal for the microcontroller, which is generated on account of the position being assumed, to an output value using a table stored in a memory outside a memory area for the firmware program, that is to say to assign the input signal to a position of the rotary switch and to simultaneously assign the position of the rotary switch to the output value in one go, and to also cause the apparatus to be operated according to the assumed position.

The method according to an embodiment of the invention provides the desired greater degree of flexibility.

### BRIEF DESCRIPTION OF THE DRAWINGS

The invention is explained in more detail below using a preferred embodiment and with reference to the drawing, in which:

FIG. 1 shows a schematic illustration of an apparatus from the prior art,

FIG. 2 shows how the apparatus according to FIG. 1 operates,

FIG. 3 shows a schematic illustration of an apparatus according to one embodiment of the invention, and

FIG. 4 shows how the apparatus according to this embodiment operates.

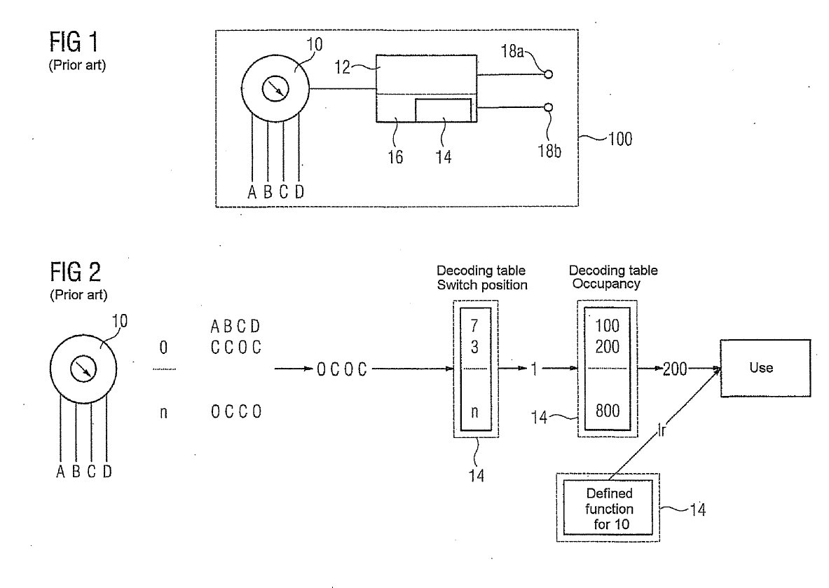

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within, the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

A known circuit breaker 100 has a decoding switch 10; the latter can be moved into many positions. The rotary switch 10 is coupled to a microcontroller 12. A firmware program runs in the microcontroller 12, the code for which program is stored in a memory area 14 of a flash memory 16.

There are four contacts A, B, C, D, and different contacts of the contacts A, B, C, D are respectively open (“0” as in “open”) or closed (“C” as in “closed”) in different switch positions. This results in a binary code. For a particular switch position, the code “OCOC” is now given. The microcontroller 12 thus receives this binary input signal.

The firmware, that is to say the memory area 14 of the flash memory 16, now stores a decoding table which can be used to reconstruct the switch position for the code “OCOC”. This is the switch position “1”, for example. The firmware additionally stores a decoding table which assigns the switch position to an occupancy; for example, the occupancy “200” is assigned to the switch position “1” in this case. This then directly results in the use, a defined function for the rotary switch 10 being assigned for the occupancy “200” in the firmware. For example, the number “200” can indicate the current intensity from which the circuit breaker “100” is intended to be triggered. The ports 18a, 18b abstractly illustrate the external effect of the microcontroller 12. This is different for each input signal and thus output value in the second table.

Since the decoding tables are both stored in the firmware, the coding of the rotary switch, that is to say the assignment of a code using the symbols “O” and “C” to a switch position, cannot be readily changed, namely cannot be changed without simultaneously modifying the firmware. The construction of the circuit breaker 100 is thus restricted to a rotary switch 10 with predetermined coding.

This was recognized and is overcome by an embodiment of the invention.

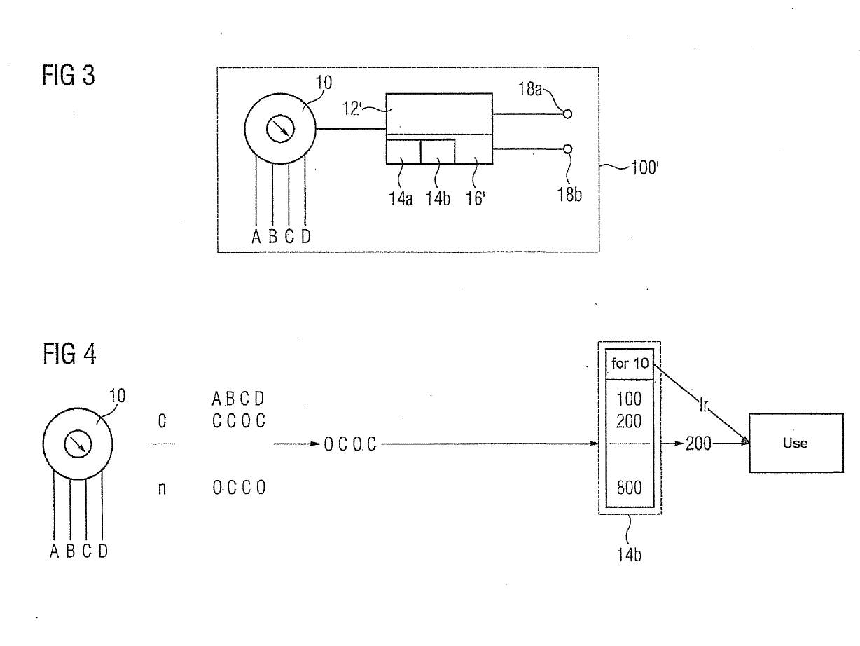

FIG. 3 shows a circuit breaker 100′ which differs from the circuit breaker 100 in the microcontroller 12′. The difference is, in particular, that two memory areas 14a and 14b of a flash memory 16′ are provided, the code for the firmware being stored in one memory area 14a and a table being stored in the other memory area 14b. This table assigns a switch position to a code with respect to the contacts A, B, C, D and assigns the occupancy to the switch position in one go, that is to say directly assigns an occupancy to a code. This is clear from FIG. 4 which corresponds to FIG. 2. There is only one table which assigns the occupancy “200” for the rotary switch 10 to the code “OCOC”, and the use directly results therefrom. The firmware directly accesses the table. It comprises suitable pointers for this purpose.

The advantage of this measure is that the table in the memory area 14b can be changed without changing the code for the firmware. The rotary switch 10 can thus be replaced with a rotary switch with different coding and only the table then needs to be replaced and the firmware does not need to be reprogrammed, for instance.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An apparatus comprising:
a rotary switch, movable into a plurality of positions, each of is the plurality of positions being assigned a different function of the apparatus and a different input signal being respectively supplied to a microcontroller during operation of the apparatus when each of the plurality of positions is assumed, wherein a firmware program is included for the microcontroller which, for each input signal, causes the apparatus to operate according to the associated function via the definition of an associated output value being run or having been run in the microcontroller; and
a memory assigned to the microcontroller, to store a table which directly assigns input signals and output values to one another, the table acting as a data source which is external with respect to the firmware program, and wherein the firmware program is designed to access the table.

2. The apparatus as claimed in claim 1, wherein program code, which determines the firmware program, is stored in the memory in a memory area other than a memory area in which the table is stored.

3. The apparatus as claimed in claim 1, wherein the memory is a read-only memory.

4. The apparatus as claimed in claim 1, wherein the apparatus is in the form of a protective switching device.

5. A method for operating an apparatus, including a rotary switch, based on a position of the rotary switch, the method comprising:
directly assigning, via a firmware program running in a microcontroller, an output value to an input signal for the microcontroller, generated on account of the position being assumed; and
using a table stored in a memory outside a memory area for code for the firmware program and consequently causing the apparatus to be operated according to the assumed position.

6. The apparatus as claimed in claim 3, wherein the read-only memory is an EEPROM, particularly preferably a flash EEPROM.

7. The apparatus as claimed in claim 6, wherein the EEPROM is a flash EEPROM.

8. The apparatus as claimed in claim 2, wherein the memory is a read-only memory.

9. The apparatus as claimed in claim 8, wherein the read-only memory is an EEPROM, particularly preferably a flash EEPROM.

10. The apparatus as claimed in claim 9, wherein the EEPROM is a flash EEPROM.

11. The apparatus as claimed in claim 4, wherein the protective switching device is a circuit breaker.
